(19) United States
(12) Patent Application Publication
(10) Pub. No.: US 2016/0350763 A1
(43) Pub. Date: Dec. 1, 2016

(54) Context-Aware Display Of Objects In Mixed Environments

(71) Applicant: Microsoft Technology Licensing, LLC, Redmond, WA (US)

(72) Inventors: Dionicio A. Avila, Issaquah, WA (US); Yang Sun, Sammamish, WA (US); Erik P. Gunvaldson, Redmond, WA (US); Pamela Bhattacharya, Redmond, WA (US); Mohamed Farouk AbdelHady, Redmond, WA (US); Ganesh Pandey, Redmond, WA (US); Zhengwen Zhu, Redmond, WA (US); John Vijay Sena Devide, Redmond, WA (US)

(21) Appl. No.: 14/726,214

(22) Filed: May 29, 2015

(51) Int. Cl. G06Q 30/00; G06F 17/30

(52) U.S. Cl. CPC G06Q 30/016; G06F 17/30867; G06F 17/30528; G06F 17/3053

(57) ABSTRACT

Concepts and technologies are described herein for providing contextually-aware discovery of solutions. In some configurations, a computing device may receive a request from a tenant. A request may be any type of request, including a service request or any other type of request for information. To process the request, the computing device may also obtain data that associates characteristics with the tenant. For example, one or more resources may maintain a database that includes a tenant identifier, data indicating the size of the tenant, the length of time a tenant has been in service, or any other type of characteristic of the tenant.

### BACKGROUND

Users of existing systems often encounter problems with software programs and hardware. To address these issues, specialized systems are configured to receive, monitor and provide responses to trouble tickets created by users. In traditional systems, when a user has a problem or requires assistance, the user may submit a request for a solution in the form of a trouble ticket in order for a service to provide a solution. The process of finding an intent of, or a solution to the request, may often be a lengthy one, requiring time and data from the customer. In some cases, even after investing time in the process, the customer may not receive a relevant solution to solve the problem. The customer may receive irrelevant solutions because an exact description of the malfunction was not entered, or because the user did not know the proper terminology to use in the trouble ticket. The relevancy of solutions to user queries is critical to providing good customer service to software users.

It is with respect to these and other considerations that the disclosure made herein is presented.

### SUMMARY

Concepts and technologies are described herein for providing contextually-aware discovery of solutions. In some configurations, a computing device may receive a request from a tenant. The computing device may also obtain data that associates characteristics with the tenant. By the use of the data associating characteristics with the tenant, the computing device may determine a tenant type. Techniques and technologies described herein determine a response to the request, such as a solution, based on the tenant type and/or other contextual data. An output including the response to the request may then be provided to the tenant.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to systems, methods, computer-readable instructions, modules, algorithms, hardware logic and/or operations as permitted by the context described above and throughout the document. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components for providing contextually-aware discovery of solutions.

FIG. 2 is a block diagram showing one example feedback process that may be used for providing contextually-aware discovery of solutions.

FIG. 3 is a flow diagram of one example process that may be used for providing contextually-aware discovery of solutions.

FIG. 4 is a flow diagram of one example feedback process that may be used for updating the efficacy of solutions provided during the process of providing contextually-aware discovery of solutions.

FIG. 5 depicts an illustrative distributed computing environment capable of executing the software components described herein for providing contextually-aware discovery of solutions.

FIG. 6 shows additional details of an example computer architecture for the components shown in FIG. 5 capable of executing the program components described in FIGS. 1-4 for providing contextually-aware discovery of solutions.

FIG. 7 depicts an illustrative distributed computing environment capable of executing the software components described herein for providing contextually-aware discovery of solutions.

### DETAILED DESCRIPTION

Concepts and technologies are described herein for providing contextually-aware discovery of solutions. In some configurations, a computing device may receive a request from a tenant. A request may be any type of request, including a service request or any other type of request for information. To process the request, the computing device may also obtain data that associates characteristics with the tenant. For example, one or more resources may maintain a database that includes a tenant identifier, data indicating the size of the tenant, the length of time a tenant has been in service, or any other type of characteristic of the tenant.

The computing device may also access one or more resources for additional contextual information that may be used to process the request. Contextual information may include, but is not limited to, a tenant request intent (e.g., a determination of the user's problem, such as, for example, delayed email, a symptom classification, supported vs. unsupported, a temperature of the request), tenant characteristics (e.g., tenant is a small business), and tenant usage characteristics (e.g., computer operation the user is experiencing difficulty completing, such as, for example, changing the payment type on an account). For instance, the computing device may access a database that associates criteria with one or more solutions. As will be described in more detail below, a database storing data defining the efficacy of individual solutions may be associated with criteria. In yet another example, the computing device may obtain contextual information that associates criteria with root cause analysis data. As will be described in more detail below, other resources for contextual information, including passive data and data received from one or more resources, such as a search engine, may also be obtained by the computing device to process the request.

The obtained contextual information is then processed to determine a response. In some configurations, the response may be based, at least in part, on a tenant type, characteristics associated with the tenant, criteria associated with a response and/or data defining one or more metrics. As will be described in more detail below, in some configurations, the data associating one or more characteristics with a tenant may be used to identify a tenant type. The one or more tenant characteristics and/or the determined tenant type may be processed with the criteria defined in the contextual information to determine a response. As will be described in more detail below, the response may include a solution or information pertaining to the request.

The response may be communicated to the tenant. In addition, after the tenant has processed the response, the tenant may provide feedback. Based on feedback received from the tenant, the computing device may determine at least one success metric based on the feedback. In some configurations, the computing system may update one or more resources, such as the database storing the efficacy of the individual solutions or any other data store, with the determine success metric. As will be described in more detail below, the stored feedback enables the system to improve the relevancy and accuracy of responses over time.

In some configurations, a system provides services and applications for a number of tenants. For illustrative purposes, a tenant may involve an entity, such as a company, person or group of people. A tenant may have a contractual relationship for a service agreement for one or more services. The service may provide tenants with solutions in response to requests that are submitted by individual tenants. The techniques described herein may be utilized to improve the efficiency of services that provide solutions for service requests. Traditionally, to get a solution, a tenant would have to generate a trouble ticket with the service provider by submitting data such as a name, username, e-mail address, problem category, details, etc. The service provider would then search for solutions based upon the category and details, and send solutions back to the tenant. If successful, the ticket is closed out. If not, the service provider may conduct an updated search for solutions based on additional information provided by the tenant. As will be described herein, a click through rate and deflection rate may be improved, as more relevant solutions may be identified before or after the generation of a trouble ticket. In addition, the complexity of the user input and processing time may be decreased.

In one illustrative example, the techniques described herein determine relevant solutions that are provided in response to a tenant's request. In some configurations, relevant solutions are provided prior to the issuance of a trouble ticket. The request may include questions about a software program, information describing a failure point or state inconsistencies, and the like. The request may include a verbatim section, which may describe a problem or failure point in a natural language (e.g., “my email inbox will not open”).

In response to such a request, a computing system may derive the intent of the tenant request by implementing a machine learning process to transform a tenant's free-form text description of the problem into a set of problem categories that are most likely related to the issue at hand. The machine learning process may reduce the number of relevant problem categories down to a manageable number. In at least one configuration, the machine learning process may reduce the number of relevant problem categories to less than 5 problem categories. The computing system may present the problem categories to the tenant, and may instruct the tenant to select the most relevant problem category (e.g., “mail”). In various configurations, the machine learning process may be performed iteratively. For example, the machine learning process may be performed first with a list of generic problem categories, followed by one or more lists of specific problem categories.

In response to receiving the relevant problem categories, the computing system may determine one or more relevant solutions based, at least in part, on characteristics of a tenant. Techniques described herein may receive and process active and/or passive input data that includes characteristics of a tenant. In addition, input data may be received from a number of sources that includes data describing a root cause analysis, solutions and other data.

Based on the obtained data, techniques described herein may determine a tenant type. One or more responses to the request may be identified based on the tenant type. In one specific example, the system may perform a root cause analysis based at least in part on the tenant type. Example techniques described herein may then provide one or more solutions in response to a request based on the tenant type and data derived from a root cause analysis.

In some configurations, solutions may be provided prior to the generation of a trouble ticket which improves the efficiency of such systems. As will be described in more detail below, a deflection rate of a process may be improved. Traditionally, the ticket creation process is inefficient and time consuming. To create a ticket, the server may ask for a plethora of user input, such as user name, email address, and sometimes multiple levels of descriptions of the problem. The process may be time consuming and frustrating for the user, especially if the solution to the trouble ticket is not effective. Deflecting the trouble ticket by providing a relevant solution prior to the ticket generation process may decrease the amount of communication between the user and the server needed to solve the problem. Therefore, by the use of the technologies described herein, user interaction with the computing device may be improved. In addition, the techniques described herein improve the use of one or more computing resources. For instance, a higher level of accuracy with respect to the identification of relevant solutions may reduce the need for users to send multiple requests, which may result in reduced network traffic and overall improved efficiency of a system, thereby providing enhanced customer satisfaction.

In some configurations, the solutions may be evaluated for historical efficacy, thereby improving the accuracy in determining the most relevant solutions to a given problem for a particular tenant type. A system may be configured to receive feedback from the tenant once the tenant has received and processed a response. From the feedback, the system may determine at least one success metric. As will be described in more detail below, the success metric may be used to update one or more data stores. By updating the resources, the relevancy of the responses to future requests are improved.

While the subject matter described herein is presented in the general context of program modules that execute in conjunction with the execution of an operating system and application programs on a computer system, those skilled in the art will recognize that other implementations may be performed in combination with other types of program modules. Generally, program modules include processes, routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for providing contextually-aware discovery of solutions will be described.

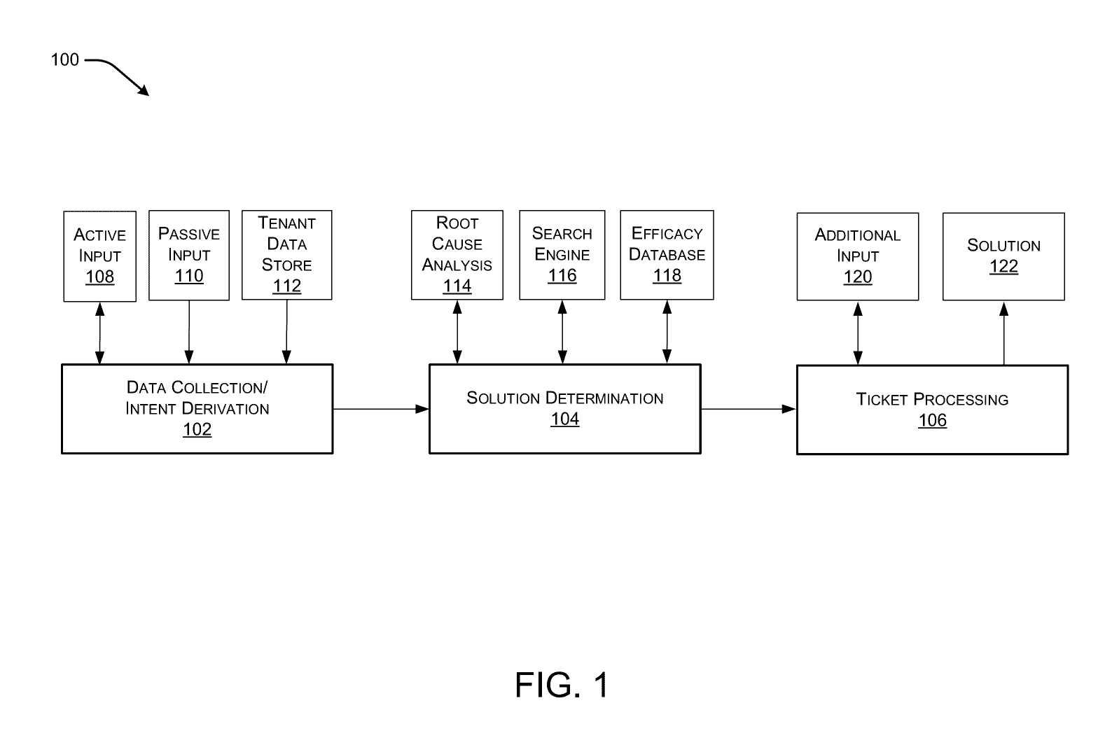

FIG. 1 is a block diagram showing aspects of one illustrative mechanism disclosed herein for providing contextually-aware discovery of solutions. As shown in FIG. 1, process blocks representing stages of a request process are depicted with one or more data resources. In general, the request process includes a data collection stage/intent derivation 102, a solution determination stage 104, and a ticket processing stage 106. As will be described below, various resources may provide input data that facilitates the identification of a relevant response to a received request.

In some configurations, at the data collection stage 102, a resource may include one or more tenants that provide active input 108 related to a problem. Active input 108 may comprise a verbatim description of the problem and/or a taxonomy-based characteristic of the problem (e.g., a generated list of problem categories). For illustrative purposes, active input 108 may include a verbatim description of a problem, i.e., “my inbox will not open.” In response to receiving the verbatim description, the computing system may implement a machine learning process to transform the verbatim description into a set (e.g., list) of problem categories that are most likely related to the intent of the request, or the issue at hand (i.e., “mail.”). The computing system may present the tenant with the set of problem categories, and instruct the tenant to select the most relevant problem category, thereby deriving the intent of the request. In some configurations, the machine learning process may be iterative, thereby providing the tenant with more than one set of problem categories. In such configurations, the first set of problem categories may be generic, and each subsequent set of problem categories may be progressively more specific.

In some configurations, a resource may include one or more computers that generate passive input 110. For illustrative purposes, passive input 110 may include any information that supplements any active input 108. For instance, if a request includes a verbatim description of a problem, i.e., “I may not connect to a server,” one or more computers made analyze such active input 108 to locate additional information. For instance, a resource may indicate that this verbatim description may be associated with a particular error code. In such an example, the error code may be provided as passive input 110 to the techniques described herein.

In some configurations, a resource may include a tenant data store (TDS) 112. The TDS 112 may include a database that stores a unique identifier for individual tenants. In addition, the TDS 112 may also associate various characteristics for individual tenants. For instance, the TDS 112 may store data indicating the number of licenses associated with each individual tenant. In other examples, the TDS 112 may store data describing a number of users associated with the tenant, an age of the tenant, demographic information associated with the tenant, a geographic location associated with the tenant, etc. These examples are used for illustrative purposes and are not to be construed as limiting.

As an illustrative example, a TDS 112 may have a record indicating that a tenant is associated with a number of characteristics, such as: 5 licenses, 4 users, and a tenant age of 3 years. Such characteristics may be associated with a tenant type referred to as: tenant type A. Whereas other characteristics of a tenant, e.g., comprising 100 licenses, 4 actual users, which has been a tenant for 3 years may be associated with a tenant type referred to as: tenant type B.

In some configurations, a resource may include data for facilitating a root cause analysis (RCA) 114. The RCA 114 may predict a root cause, i.e., the type or context, of a particular problem based upon tenant active input 108 and/or passive input 110. The RCA may predict the root cause of the particular problem by determining a relevance of one or more words of the input and mapping the result to a prediction based at least in part on the relevance, and/or by evaluating a statistical distribution of root causes for a tenant type.

In some configurations, the RCA 114 may determine the relevance of one or more words of the input by applying the input to a weighted dictionary, and assign a weight to each word of the input. In some configurations, the weights assigned to words may be determined based on historical information associated with problems and/or tenant data from the TDS 112. For instance, the input “Exchange” may have a low weight because it is common to many root causes. Conversely, the input “MX Record Incorrect” may have a high weight because it may be very specific to a root cause. In addition, the weight allocated to each word may be determined based on placement of the word in the verbatim description. Using the example above, the placement of “MX Record Incorrect” together in a string may be assigned a higher weight together than any of the three would individually, if out of order. For another example, the seventh word in an eight word string may be allocated a lower weight than the second word in the eight word string, or vice versa.

The RCA 114 may determine the type or context of the root cause of the problem by mapping the weighted inputs. The mapping may adjust the structure or wording of the input, and generate an efficient search engine query of N words. In one example, the efficient search engine query comprises 5 words. In other examples, the efficient search engine query may comprise a greater or lesser number of words. The restructure of input words may allow the RCA 114 to leverage the most important keywords to drive the search for the most relevant solutions. In some configurations, the RCA 114 may send the search engine query to a search engine 116 at the solution determination stage 104.

As an illustrative example, the input for a particular problem may comprise the following:

Workload: Exchange;

Product: Outlook for Windows; and

Title/Description: “I have issues with Calendar features. I want to transfer contacts from one account to another.”

The RCA 114 may automatically generate weight to each of the inputs, and map the input with a set of words extracted to generate the Predicted Root Cause: “Cloud Services Root Cause\Exchange\Administration\Customer Issue\How to: Configure Full Mailbox Access.”

The RCA 114 may then change the structure of the wording, leveraging keywords to provide the most efficient search engine query for the problem: “exchange Configure Mailbox Access.”

In some configurations, the RCA 114 may include a database that stores root cause data associated with particular problems. In addition, the RCA 114 may associate the root cause data of particular problems with types of tenants. For instance, the RCA 114 may store a root cause distribution associated with a particular problem that a type of tenant has experienced. In such an example, the RCA 114 may know, for Tenant Type A, 60% of the time, the root cause of problem X is K, 30% of the time, the root cause of problem X is L, and 10% of the time, the root cause of problem X is M. In such configurations, the RCA 114 may place a greater emphasis on a solution to problem X, as it is statistically more likely that K is the root cause of problem X. Additionally or alternatively, the RCA 114 may predict, based on the statistical analysis, the root cause of problem X to be K.

It should be appreciated that variations to the RCA 114 are contemplated, such as for online and offline versions.

In some configurations, a resource may include an efficacy database 118. The efficacy database 118 may include a database that stores a list of solutions provided for problems and/or the historical efficacy of individual solutions. In addition, the efficacy database 118 may receive the list of solutions from the search engine 116, and may provide an effectiveness metric, i.e., a determination of an effectiveness, of each of the solutions provided for a particular tenant type. In some examples, the effectiveness metric may a score assigned to the solution based on historical data, such as a tenant solution request being deflected or the tenant initiating the ticket processing stage 106.

The efficacy database 118 may maintain the historical data for problems associated with tenant types for the lifetime of a program or for a limited time. In some examples, the efficacy database 118 may store historical information for three to six months. In other examples, the efficacy database 118 may store historical information for a longer or shorter period.

In some configurations, the techniques disclosed herein may rank the solutions in a hierarchy based on the effectiveness metric. For instance, the most historically effective solution to a particular problem for a particular tenant type may be given a higher effectiveness score, and therefore ranked highest on the list.

The hierarchically ranked list may be provided to the tenant. In some configurations, at the solution determination stage 104, the system may monitor active and passive data with respect to the solutions provided in response to the query. The active and passive data may be stored by the RCA 114 and the efficacy database 118 as feedback. For example, solution Z was listed as the highest ranked, most relevant solution provided to Tenant Type A to solve problem X, and Tenant Type A clicked on the link to solution Z. After clicking on the link, Tenant Type A did not select another link or create a need for the system to generate a trouble ticket. Therefore, the system may deem solution Z as a relevant solution for problem X and any tenant labeled as Tenant Type A. In response, an effectiveness score or other metric for solution Z in the efficacy database may be increased. In addition, the RCA 114 may update the root cause distribution for Tenant Type A to reflect the input from the feedback.

In some configurations, if the solutions presented at the solution determination stage 104 do not solve the problem for the querying tenant, the tenant may proceed to the ticket processing stage 106. At the ticket processing stage, the computing system may request additional input 120 from the tenant. For instance, the computing system may request a more in depth description of the problem, confirmation of the tenant's email address, and the like. In response to receiving the additional input 120 from the tenant, the computing system may generate a trouble ticket, and may process the ticket to identify a relevant solution 122 to the problem using the techniques described herein.

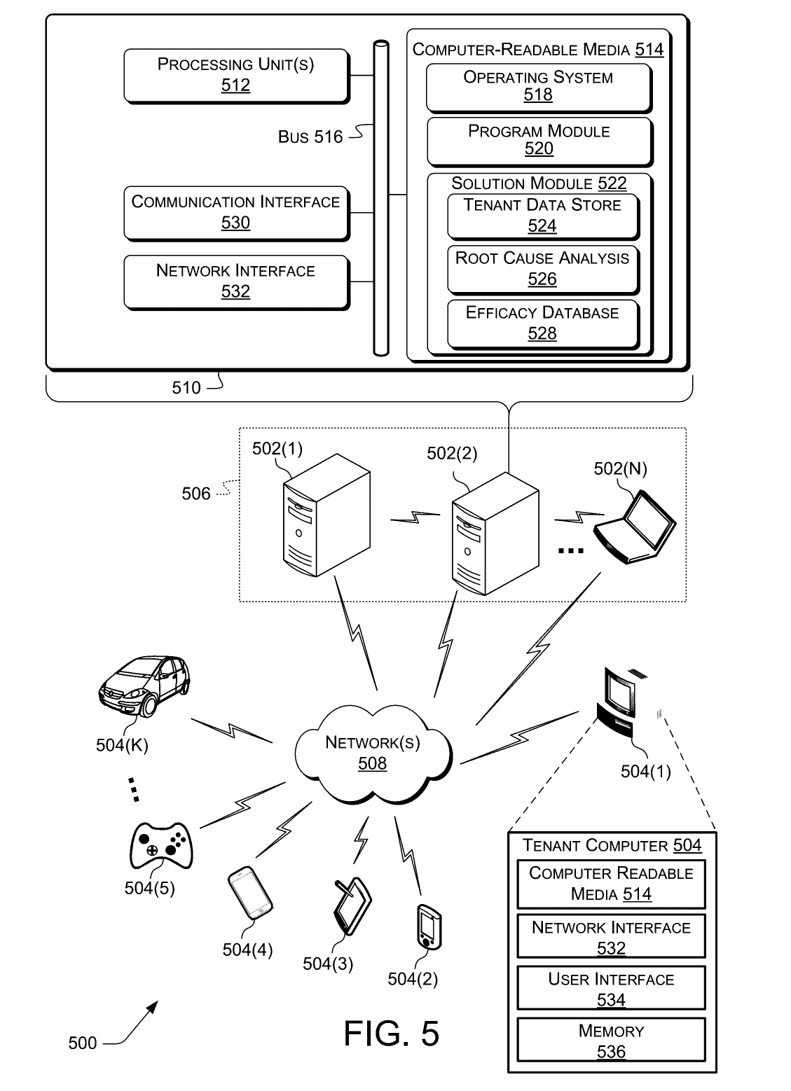

In some configurations, aspects of the techniques described herein may be implemented on one or more computing devices (502 of FIG. 5), which may be in the form of a personal computer, server, or any other device. The computing device 502 may also include a program module 520 configured to manage techniques described herein and interactions between a user and the computing device 502. The program module 520 may be in the form of a productivity application, a CRM application, an operating system component or any other application. It is understood that the computing device 502 may operate in conjunction with one or more other computing devices 502(1)-502(n), such as in a cluster (506 of FIG. 5), to implement aspects and techniques described herein.

The data described herein may be stored in the computing device 502 or a local computer. As may be appreciated, the computing device 502 may store and communicate the input data allowing a centralized service to coordinate a number of client computers, such as the tenant computing device 504. The computing device 502 may also include components for executing one or more techniques described herein.

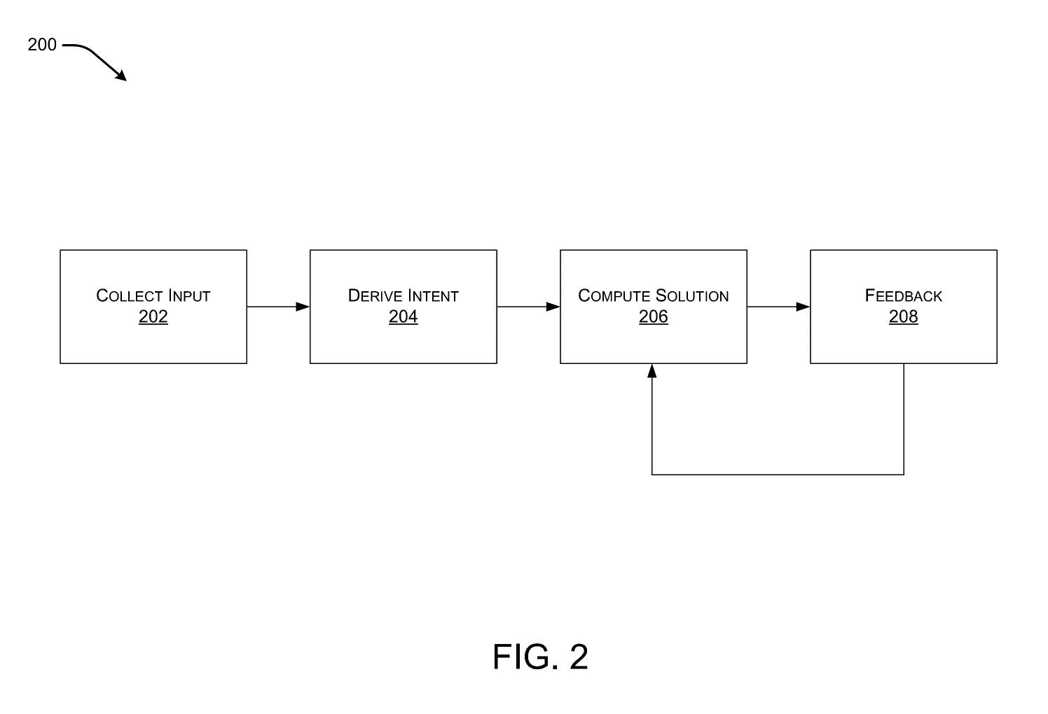

FIG. 2 is a block diagram showing one example feedback process 200 that may be used for providing contextually-aware discovery of solutions. It should be understood that the operations of the processes and methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include processes, routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As will be described in more detail below, in conjunction with FIGS. 1, 5, 6, and 7, the operations of each process are described herein as being implemented, at least in part, by an application, component and/or circuit, such as the program module 520 and/or a server module. Although the following illustration refers to the components of FIGS. 1, 5, 6 and 7, it can be appreciated that the operations of the processes may be also implemented in many other ways. For example, the processes may be implemented, at least in part, by computer processor or processor of another computer. In addition, one or more of the operations of each process may alternatively or additionally be implemented, at least in part, by a chipset working alone or in conjunction with other software modules. Any service, circuit or application suitable for providing contextual data indicating the position or state of any device may be used in operations described herein.

At block 202, the computing device (502 of FIG. 5) may collect input from a tenant. The input may be associated with a tenant request, i.e., input related to a problem or question the tenant has about a service. The input may comprise active (e.g., verbatim description) and/or passive input (e.g., indirect indication of a problem recognized by a computer resource manager).

At block 204, the computing device may derive an intent of the tenant with regard to the request. For instance, the computing device may determine, based on the verbatim input, a category of the problem experienced by the tenant, and what the tenant intends as a result. In some configurations, the computing device may implement a machine learning process to derive the intent of the tenant request. In such configurations, the computing device may present the tenant with a set of problem categories, based at least in part on the verbatim description, and may instruct the tenant to select the most relevant problem category to the problem.

In some configurations, the computing device may predict a type or context of a root cause of the problem experienced by the tenant. The root cause may be determined by applying the words of the tenant request (input) to a weighted dictionary. The computing device may map each of the words of the tenant request based on a weight applied to each word, and determine a predicted root cause based on the weights. Additionally or alternatively, the root cause analysis may be based on a stored root cause distribution. The root cause distribution may be a statistical analysis of the root causes for a particular problem experienced by tenants with characteristics similar to the requesting tenant (i.e., same tenant type). After determining the root cause, the computing device may derive the intent from the predicted root cause.

In some configurations, the computing device may generate an efficient search engine query based at least predicted root cause and the weight assigned to tenant request words. At block 206, the computing device may compute a solution to the tenant request (problem). In some configurations, the solution may be computed by sending the efficient search engine query to a search engine, such as search engine 116. The search engine may be an external search engine, e.g., BING, GOOGLE, FACEBOOK, etc., or the search engine may be internal to the server.

In response to the search engine query, the computing device may receive a list of one or more solutions to the tenant request. The computing device may evaluate each of the solutions for historical effectiveness based at least in part on characteristics of the requesting tenant. In some configurations, the computing device may evaluate the efficacy of each solution based on one or more characteristics of the requesting tenant (i.e., a tenant type), and may assign each solution a success metric (e.g., a score). Based at least in part on the success metric of each solution, the computing device may rank the solutions, and may communicate the ranked solutions to the requesting tenant in a hierarchical list.

At block 208, the computing device may receive feedback from the requesting tenant. The feedback may be in the form of an indication of a selection of a first solution, a selection of a second solution, a successful solution, no further action by the tenant related to the request, the creation of a trouble ticket, or any other action related to the tenant request. For instance, the computing device may receive an indication that solution 1 solved the problem. It is understood that the indication may be a passive input, e.g., the computing device recognizes that the tenant has accessed a desired program.

Based on the feedback received, the computing device may update the programs used to achieve block 206. For instance, if a solution was successful, the success metric of that solution for the problem experienced by the tenant type will be increased (i.e., assigned a higher score in subsequent requests). For another example, the weights associated with each input word in the root cause analysis may be updated based at least in part on the success of the list of solutions derived from the efficient search engine query.

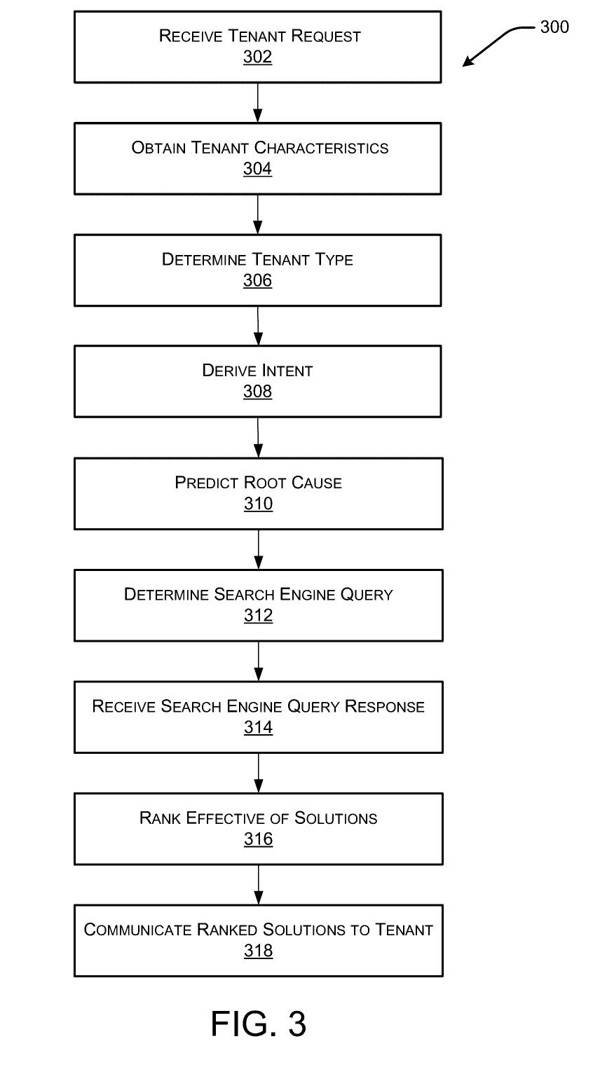

FIG. 3 is a flow diagram of one example process that may be used for providing contextually-aware discovery of solutions.

At block 302, a computing device, such as computing device 202, may receive a tenant request. The tenant request may include administrative questions about a software program, information describing a failure point or state inconsistencies, and the like. The request may include a verbatim section, which may describe a problem or failure point in a natural language. Additionally or alternatively, the request may include a taxonomy-based characteristic section, which may list pre-determined categories associated with the problem or failure point.

At block 304, the computing device may obtain one or more characteristics of the tenant (e.g., size of the tenant, how long they have been a tenant, etc.). The computing device may obtain the characteristics directly from the tenant, from a database, such as a tenant data store 112, or both.

At block 306, the computing device may determine a type of the tenant that submitted the request. In some configurations, the computing device may determine the tenant type based on the characteristics obtained at block 304. In some configurations, the computing device may access a database, such as a tenant data store 112, which may provide a tenant type of the particular tenant making the request.

At block 308, the computing device derives the tenant's intent

At block 310, the computing device predicts a root cause for the problem or request from the tenant. The computing device may predict the root cause by applying the tenant request to a weighted dictionary, and assigning a weight to each word of the input. Based at least in part on the assigned weights, the computing device may predict a root cause of the problem. In some configurations, the computing device may predict the root cause based at least in part on a root cause distribution. In such configurations, the root cause distribution may be based on tenant characteristics and/or tenant type.

At block 312, the computing device may determine an efficient search engine query. The computing device may determine the efficient search engine query of N words based at least in part on the weight assigned to each word of the request, as described at block 310. In some configurations, the search engine query may comprise 5 words. In other configurations, the search engine query may comprise a greater or lesser number of words. After the determination of the efficient search engine query, the computing device may send the efficient search engine query to a search engine.

At block 314, the computing device may receive the search engine query response from the search engine. In some configurations, the search engine query response may comprise one or more relevant solutions to the problem associated with the tenant request.

At block 316, the computing device may rank the effectiveness of the one or more solutions received from the search engine at block 314. In some configurations, the ranking may be based at least in part on historical effectiveness of the one or more solutions to the same or similar problem experienced by one or more tenants with similar characteristics of the requesting tenant. In some configurations, the computing device may produce a list of solutions ranked in hierarchical order based effectiveness.

At block 318, the computing device may communicate the list of ranked solutions to the tenant. In some configurations, the most effective solutions to the problem for the same or similar tenant type may be displayed at the top of the list.

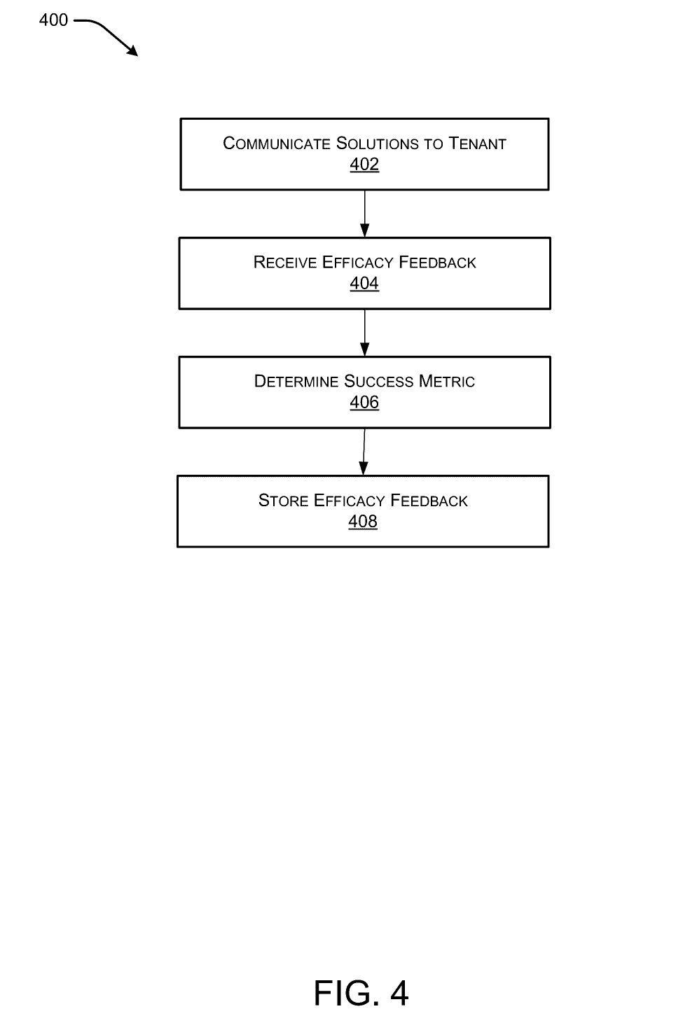

FIG. 4 is a flow diagram of one example feedback process that may be used for updating the efficacy of solutions provided during the process of discovering relevant solutions.

At block 402, the computing device may communicate the list of ranked solutions to the tenant. In some configurations, the most effective solutions to the problem for the same or similar tenant type may be displayed at the top of the list.

At block 404, the computing device may receive efficacy feedback from the tenant. The efficacy feedback may comprise a selection of a first solution, a selection of a second solution, an indication of a successful solution, no further action by the tenant related to the request, the creation of a trouble ticket, or any other tenant action related to the tenant request.

At block 406, the computing device may determine a success metric based at least in part on the efficacy feedback. For instance, the computing device may receive an indication that solution A was ranked highest, selected by the tenant, and was successful in solving the problem associated with the tenant request. For another example, the computing device may receive an indication that solution A was not successful, but that the tenant subsequently selected solution B, which solved the problem associated with the tenant request.

At block 408, the computing device may store the efficacy feedback. The efficacy feedback may be stored in the RCA, the efficacy database, or any other database of the computing device.

FIG. 5 depicts an illustrative distributed computing environment 500 capable of executing the software components described herein for providing contextually-aware discovery of solutions. As shown in FIG. 5, various devices and/or components of environment 500 include computing devices 502(1)-502(N) (individually or collectively referred to herein with reference 502), where N is any integer greater than or equal to 1, and tenant computing devices 504(1)-504(K) (individually or collectively referred to herein with reference 504), where K is any integer greater than or equal to 1. In some examples, N=K; in other examples, N>K or N<K. Although illustrated as, e.g., desktop computers, laptop computers, tablet computers, or cellular phones, computing devices 502 or tenant computing devices 504 may include a diverse variety of device categories, classes, or types and are not limited to a particular type of device.

As may be appreciated, the computing device 502 may host a number of services such as the XBOX LIVE gaming service provided by MICROSOFT CORPORATION of Redmond Wash. In addition, as described above, the computing device 502 may host services that may provide data or processing for the techniques described herein. In the illustrated example, computing devices 502(1)-502(N) may be computing nodes in a cluster 506, e.g., a cloud service such as MICROSOFT AZURE. Cloud computing permits computing resources to be provided as services rather than a deliverable product. For example, in a cloud-computing environment, computing power, software, information, and/or network connectivity are provided (for example, through a rental agreement) over a network, such as the Internet. In the illustrated example, tenant computing devices 504 may be clients of cluster 506 and may submit jobs to cluster 506 and/or receive job results from cluster 506. Computing devices 502(1)-502(N) in cluster 506 may, e.g., share resources, balance load, increase performance, or provide fail-over support or redundancy. In some examples, some of the computing devices 502 may be hosted by a cloud service and others hosted at a customer's site. Tenant computing devices 504 may additionally or alternatively operate in a cluster or grouped configuration.

By way of example and not limitation, computing devices 502 or 504 may include, but are not limited to, server computers or blade servers such as Web servers, map/reduce servers or other computation engines, or network-attached-storage units (e.g., 502(1)), laptop computers, thin clients, terminals, or other mobile computers (e.g., 502(N)), wearable computers such as smart watches or biometric or medical sensors, implanted computing devices such as biometric or medical sensors, computer navigation client computing devices, satellite-based navigation system devices including global positioning system (GPS) devices and other satellite-based navigation system devices (e.g., 504(2), represented graphically as a PDA), tablet computers or tablet hybrid computers (e.g., 504(3)), smartphones, mobile phones, mobile phone-tablet hybrid devices, or other telecommunication devices (e.g., 504(4)), portable or console-based gaming devices or other entertainment devices such as network-enabled televisions, set-top boxes, media players, cameras, or personal video recorders (PVRs) (e.g., 504(5), represented graphically as a gamepad), automotive computers such as vehicle control systems, vehicle security systems, or electronic keys for vehicles (e.g., 504(K), represented graphically as an automobile), personal data assistants (PDAs), desktop computers (e.g., 504(1)), or integrated components for inclusion in computing devices, appliances, or other computing devices configured to participate in or carry out nexus determination as described herein, e.g., for software debugging or monitoring purposes. In some examples, as indicated, computing devices, e.g., computing devices 502(1) and 502(2), may intercommunicate to participate in or carry out the contextually-aware discovery of solutions as described herein.

Different devices or types of devices may play different roles in the process of discovering relevant solutions. For instance, mobile devices used multiple users of a tenant may encounter particular device-specific problems which may require a solution. The tenant may query for a solution pertaining to the mobile devices, such as tenant computing device 504(3). In such an example, computing device 502 may narrow the search for solutions based at least in part on the query pertaining to mobile devices.

In some configurations, computing device 502 and tenant computing device 504 may communicate via one or more networks 508. For example, networks 508 may include public networks such as the Internet, private networks such as an institutional or personal intranet, cellular networks, or combinations of private and public networks. Networks 508 may also include any type of wired or wireless network, including but not limited to local area networks (LANs), wide area networks (WANs), satellite networks, cable networks, Wi-Fi networks, WiMAX networks, mobile communications networks (e.g., 3G, 4G, and so forth) or any combination thereof. Networks 508 may utilize communications protocols, such as, for example, packet-based or datagram-based protocols such as Internet Protocol (IP), Transmission Control Protocol (TCP), User Datagram Protocol (UDP), other types of protocols, or combinations thereof. Moreover, networks 508 may also include a number of devices that facilitate network communications or form a hardware infrastructure for the networks, such as switches, routers, gateways, access points, firewalls, base stations, repeaters, backbone devices, and the like. Networks 508 may also include devices that facilitate communications between computing device 502 or tenant computing device 504 using bus protocols of various topologies, e.g., crossbar switches, INFINIBAND switches, or FIBRE CHANNEL switches or hubs.

In some examples, networks 508 may further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), other standards, e.g., BLUETOOTH, cellular-telephony standards such as GSM, LTE, or WiMAX, or multiples or combinations thereof.

As illustrated in FIG. 5, details of an example computing device 502(2) are illustrated at inset 510. The details of example computing device 502(2) may be representative of others of computing device 502 or tenant computing device 504. However, individual ones of the computing devices 502 or tenant computing device 504 may include additional or alternative hardware and/or software components. Computing device 502(2) may include one or more processing units 512 operably connected to one or more computer-readable media 514 such as via a bus 516, which in some instances may include one or more of a system bus, a data bus, an address bus, a Peripheral Component Interconnect (PCI) Express (PCIe) bus, a PCI bus, a Mini-PCI bus, and any variety of local, peripheral, or independent buses, or any combination thereof. In some examples, plural processing units 512 may exchange data through an internal interface bus (e.g., PCIe), rather than or in addition to network 508. While in this example the processing units 512 are described as residing on the computing device 502(2), the processing units 512 may also reside on different computing devices 502 or tenant computing devices 504 in some examples. In some examples, at least two of the processing units 512 may reside on different computing devices 502 or tenant computing devices 504. In such examples, multiple processing units 512 on the same computing device 502 or tenant computing device 504 may use an interface bus 516 of the computing device 502 or tenant computing device 504 to exchange data, while processing units 512 on different computing devices 502 or tenant computing devices 504 may exchange data via networks 508.

Processing units 512 may be or include one or more single-core processors, multi-core processors, CPUs, GPUs, general-purpose graphics processing units (GPGPUs), or hardware logic components configured, e.g., via specialized programming from modules or APIs, to perform functions described herein. For example, and without limitation, illustrative types of hardware logic components that may be used in or as processing units 512 include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Digital Signal Processors (DSPs), and other types of customizable processors. For example, a processing unit 512 may represent a hybrid device, such as a device from ALTERA or XILINX that includes a CPU core embedded in an FPGA fabric. These or other hardware logic components may operate independently or, in some instances, may be driven by a CPU. In some examples, at least some of computing devices 502 or tenant computing device 504 may include a plurality of processing units 512 of multiple types. For example, the processing units 512 in computing device 502(2) may be a combination of one or more GPGPUs and one or more FPGAs. Different processing units 512 may have different execution models, e.g., as is the case for graphics processing units (GPUs) and central processing unit (CPUs). In some examples, processing units 512, computer-readable media 514, and modules or engines stored on computer-readable media 514 may together represent an ASIC, FPGA, or other logic device configured to carry out the functions of such modules or engines.

Computer-readable media described herein, e.g., computer-readable media 514, includes computer storage media and/or communication media. Computer storage media includes tangible storage units such as volatile memory, nonvolatile memory, and/or other persistent and/or auxiliary computer storage media, removable and non-removable computer storage media implemented in any method or technology for storage of information such as computer-readable instructions, data structures, program modules, or other data. Computer storage media includes tangible or physical forms of media included in a device or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or memories, storage, devices, and/or storage media that may be used to store and maintain information for access by a computing device 502 or tenant computing device 504.

In contrast to computer storage media, communication media may embody computer-readable instructions, data structures, program modules, or other data in a modulated data signal, such as a carrier wave, or other transmission mechanism. As defined herein, computer storage media does not include communication media.

In some examples, computer-readable media 514 may store instructions executable by the processing units 512 that, as discussed above, may represent a processing unit incorporated in computing device 502. Computer-readable media 514 may additionally or alternatively store instructions executable by external processing units such as by an external CPU or external processor of any type discussed above. In some examples at least one processing unit 512, e.g., a CPU, GPU, or hardware logic device, is incorporated in computing device 502, while in some examples at least one processing unit 512, e.g., one or more of a CPU, GPU, or hardware logic device, is external to computing device 502.

Computer-readable media 514 may store, for example, executable instructions of an operating system 518, a program module 520, a solution module 522, and other modules, programs, or applications that are loadable and executable by processing units 512. In various examples, the solution module 522 may comprise a tenant data store 524, a root cause analysis (RCA) 526, and an efficacy database 528. In such examples, the solution module 522 may execute the steps of the solution determination stage 104, described above in FIG. 1.

In some examples not shown, one or more of the processing units 512 in one of the computing devices 502 or tenant computing devices 504 may be operably connected to computer-readable media 514 in a different one of the computing devices 502 or tenant computing devices 504, e.g., via communications interface 530 and/or network interface 532, and network 508. For example, computing device 502 may receive a query from tenant computing device 504(5) via the communication interface 530 and the network 508. The solution module 522 may process the query, and determine one or more relevant solutions based at least in part on the tenant type submitting the query.

Computer-readable media 514 of the computing device 502 may store an operating system 518. In some examples, operating system 518 is not used (commonly referred to as a “bare metal” configuration). In some examples, operating system 518 may include components that enable or direct the computing device 502 to receive data via various inputs (e.g., user controls, network or communications interfaces, memory devices, or sensors), and process the data using the processing units 512 to generate output. The operating system 518 may further include one or more components that present the output (e.g., display an image on an electronic display, store data in memory, transmit data to another computing device, etc.). The operating system 518 may enable a tenant to submit a request or query to the computing device via a user interface 534. Additionally, the operating system 518 may include components that perform various functions generally associated with an operating system, e.g., storage management and internal-device management.

Computing device 502 may also include one or more communications interfaces 530 to enable wired or wireless communications between computing devices 502 or tenant computing devices 504 and other networked computing devices 502 or tenant computing devices 504 involved in providing contextually-aware discovery of solutions or running apps, or other computing devices, over networks 508. Such communications interfaces 530 may include one or more transceiver devices, e.g., network interface controllers (NICs) such as Ethernet NICs or other types of transceiver devices, to send and receive communications over a network. The processing units 512 may exchange data through respective communications interfaces 530. In some examples, the communications interface 530 may be a PCIe transceiver, and the network 508 may be a PCIe bus. In some examples, the communications interface 530 may include, but is not limited to, a transceiver for cellular (3G, 4G, or other), WI-FI, Ultra-wideband (UWB), BLUETOOTH, or satellite transmissions. The communications interface 530 may include a wired I/O interface, such as an Ethernet interface, a serial interface, a Universal Serial Bus (USB) interface, an INFINIBAND interface, or other wired interfaces. For simplicity, these and other components are omitted from the illustrated computing device 502.

In some examples, tenant computing device 504 may include user interface 534. User interface 534 may include one or more input devices, integral or peripheral to tenant computing device 504. The input devices may be user-operable, or may be configured for input from other tenant computing device 504. Examples of input devices may include, e.g., a keyboard, keypad, a mouse, a trackball, a pen sensor or smart pen, a light pen or light gun, a game controller such as a joystick or game pad, a voice input device such as a microphone, voice-recognition device, or speech-recognition device, a touch input device, a gestural input device such as a touchscreen, a grip sensor, an accelerometer, another haptic input, a visual input device such as one or more cameras or image sensors, and the like.

In some examples, tenant computing device 504 may include a memory 536. Memory 536 may comprise a plurality of data including, but not limited to, tenant data (e.g., size of the tenant, number of licenses associated with the tenant, age of the tenant). In some examples, the tenant computing device 504 may communicate changes to the tenant data to the computing device 502 via a communication interface 530 and/or network interface 532 and the network 508. The computing device 502 may subsequently update the tenant data store 524.

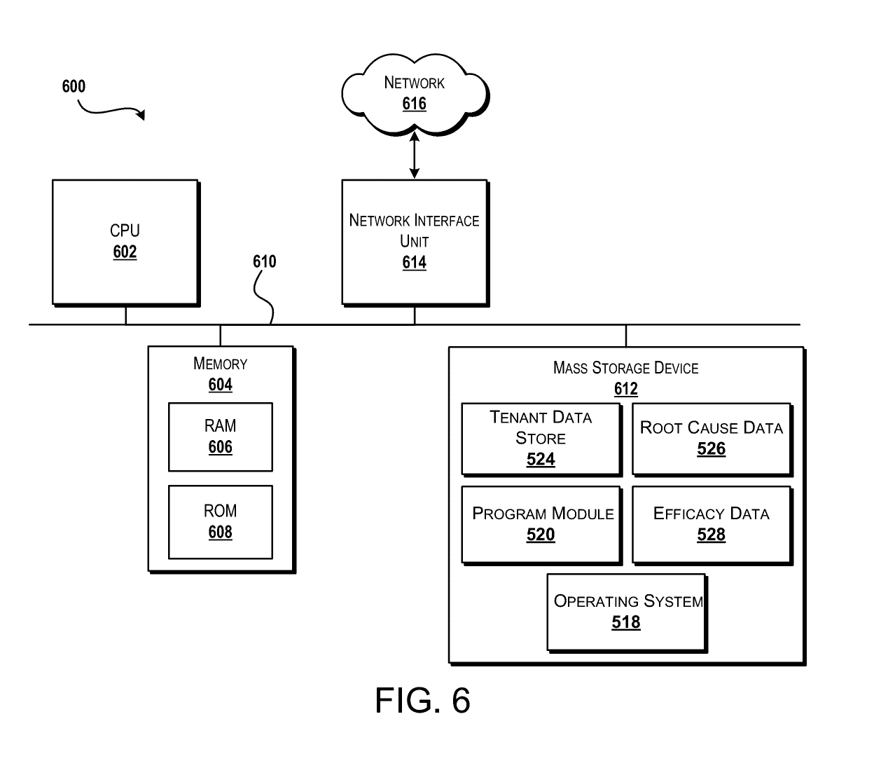

FIG. 6 shows additional details of an example computer architecture for the components shown in FIG. 5 capable of executing the program components described above for providing contextually-aware discovery of solutions. The computer architecture shown in FIG. 6 illustrates a game console, conventional server computer, workstation, desktop computer, laptop, tablet, phablet, network appliance, personal digital assistant (“PDA”), e-reader, digital cellular phone, or other computing device, and may be utilized to execute any of the software components presented herein. For example, the computer architecture shown in FIG. 6 may be utilized to execute any of the software components described above. Although some of the components described herein are specific to the computing device 502, it may be appreciated that such components, and other components may be part of the tenant computing device 504.

The computer architecture 600 illustrated in FIG. 5 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic processes that help to transfer information between elements within the computer architecture 600, such as during startup, is stored in the ROM 608. The computer architecture 600 further includes a mass storage device 612 for storing an operating system 518, and one or more application programs including, but not limited to, a program module 520 and contextual data stored in one or more of a tenant data store 524, a root cause analysis 526, and/or an efficacy database 528.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, the phrase “computer storage medium,” “computer-readable storage medium” and variations thereof, does not include waves, signals, and/or other transitory and/or intangible communication media, per se.

According to various configurations, the computer architecture 600 may operate in a networked environment using logical connections to remote computers through the network 508 and/or another network (not shown). The computer architecture 600 may connect to the network 508 through a network interface unit 614, such as network interface 532, connected to the bus 510. It should be appreciated that the network interface unit 614 also may be utilized to connect to other types of networks and remote computer systems.

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 6, may include other components that are not explicitly shown in FIG. 6, or may utilize an architecture completely different than that shown in FIG. 6.

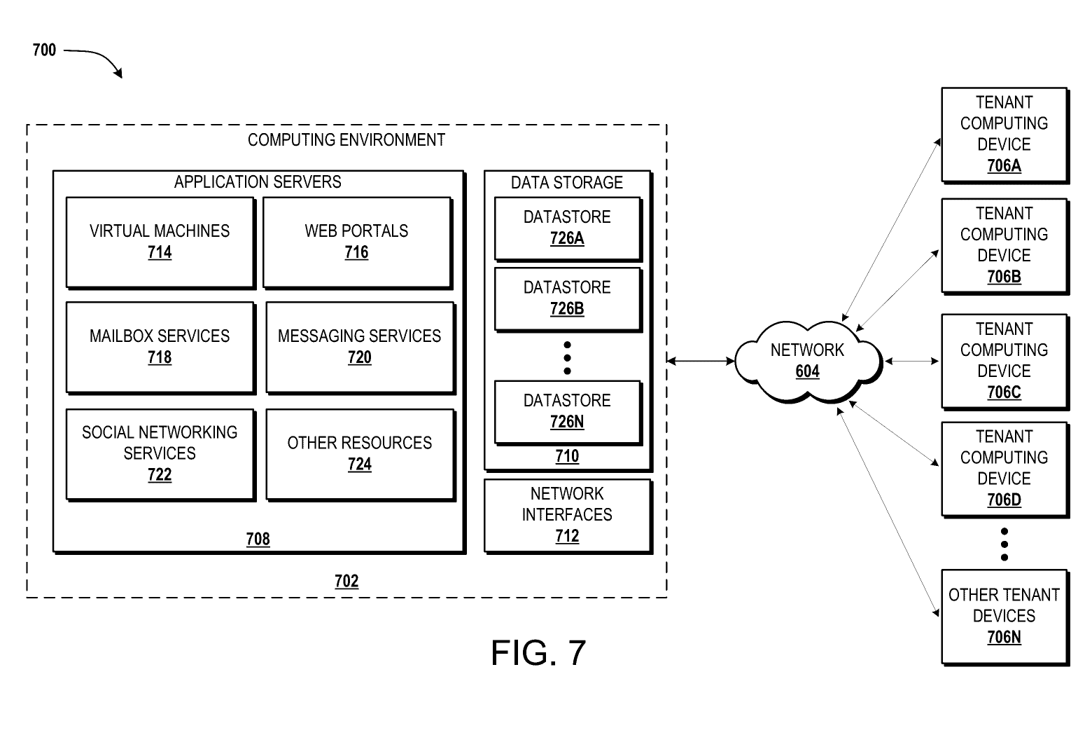

FIG. 7 depicts an illustrative distributed computing environment 700 capable of executing the software components described herein for providing contextually-aware discovery of solutions, among other aspects. Thus, the distributed computing environment 700 illustrated in FIG. 7 can be utilized to execute any aspects of the software components presented herein.

According to various implementations, the distributed computing environment 700 includes a computing environment 702 operating on, in communication with, or as part of the network 704. The network 704 may be or may include the network 508, described above with reference to FIG. 5. The network 704 also can include various access networks. One or more tenant computing devices 706A-706N (hereinafter referred to collectively and/or generically as “tenants 706”) can communicate with the computing environment 702 via the network 704 and/or other connections (not illustrated in FIG. 7). It should be understood that any number of tenants 706 may communicate with the computing environment 702. Two example computing architectures for the tenants 706 are illustrated and described herein with reference to FIG. 6. It should be understood that the illustrated tenants 706 and computing architectures illustrated and described herein are illustrative, and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. In the illustrated configuration, the application servers 708 host one or more virtual machines 714 for hosting applications or other functionality. According to various implementations, the virtual machines 714 host one or more applications and/or software modules for providing enhanced control of one or more robots. It should be understood that this configuration is illustrative, and should not be construed as being limiting in any way. The application servers 708 also host or provide access to one or more portals, link pages, Web sites, and/or other information (“Web portals”) 716.

According to various implementations, the application servers 708 also include one or more mailbox services 718 and one or more messaging services 720. The mailbox services 718 can include electronic mail (“email”) services. The mailbox services 718 also can include various personal information management (“PIM”) services including, but not limited to, calendar services, contact management services, collaboration services, and/or other services. The messaging services 720 can include, but are not limited to, instant messaging services, chat services, forum services, and/or other communication services.

The application servers 708 also may include one or more social networking services 722. The social networking services 722 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 722 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 722 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 722 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 722 are not mentioned herein for the sake of brevity. As such, the above configurations are illustrative, and should not be construed as being limited in any way. According to various implementations, the social networking services 722 may host one or more applications and/or software modules for providing the functionality described herein for providing enhanced control of one or more robots. For instance, any one of the application servers 708 may communicate or facilitate the functionality and features described herein. For instance, a social networking application, mail client, messaging client or a browser running on a phone or any other client 706 may communicate with a networking service 722 and facilitate the functionality, even in part, described above with respect to FIGS. 1-4.

As shown in FIG. 7, the application servers 708 also can host other services, applications, portals, and/or other resources (“other resources”) 724. The other resources 724 can include, but are not limited to, document sharing, rendering or any other functionality. It thus can be appreciated that the computing environment 702 can provide integration of the concepts and technologies disclosed herein provided herein with various mailbox, messaging, social networking, and/or other services or resources.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual datastores 726A-726N (hereinafter referred to collectively and/or generically as “datastores 726”). The datastores 726 are configured to host data used or created by the application servers 708 and/or other data. Although not illustrated in FIG. 7, the datastores 726 also can host or store web page documents, word documents, presentation documents, data structures, algorithms for execution by a recommendation engine, and/or other data utilized by any application program or another module, such as the tenant data store 524. Aspects of the datastores 726 may be associated with a service for storing files.

The computing environment 702 can communicate with, or be accessed by, the network interfaces 712, such as network interface 532. The network interfaces 712 can include various types of network hardware and software for supporting communications between two or more computing devices including, but not limited to, the tenants 706 and the application servers 708. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the tenants 706. It should be understood that the tenants 706 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 700 to utilize the functionality described herein for providing contextually-aware discovery of solutions, among other aspects.

Based on the foregoing, it should be appreciated that technologies for providing contextually-aware discovery of solutions are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

### Example Clauses

A: A computer-implemented method, comprising: receiving a request from a tenant; obtaining data defining characteristics associated with the tenant; determining a tenant type based on the characteristics; determining a response to the request based, at least in part, on the tenant type; and generating an output comprising the response.

B: A method as paragraph A describes, further comprising: obtaining data defining a historical effectiveness of one or more responses; determining a hierarchical rank of the one or more responses based at least in part on the data defining the historical effectiveness; and selecting at least one response of the one or more responses based, at least in part, on the hierarchical rank.

C: A method as paragraph B describes, further comprising: communicating the selected response to the tenant; receiving feedback associated with the response; determining at least one success metric based on the feedback; and updating a resource storing the data defining the historical effectiveness of the one or more responses, wherein the update includes the at least one success metric.

D: A method as paragraph C describes, further comprising: receiving a second request from a second tenant, the second tenant being of the same type as the tenant; and determining a response to the second request based at least in part on the updated resource storing the data defining the historical effectiveness.

E: A method as paragraphs A-D describe, further comprising: prior to determining a response to the request, obtaining data defining a root cause analysis (RCA) of one or more requests; predicting a root cause of the request based at least in part on the data defining the RCA; determining a search query; querying one or more search engines; and receiving a list of responses to the request.

F: A method as paragraph E describes, wherein the predicting a root cause of the request further comprises: applying one or more words of the request to a weighted dictionary; assigning one or more words of the request to a weighted dictionary; assigning a weight to the one or more words of the request; and mapping the one or more words based at least in part on the assigned weight.

G: A method as paragraphs E-F describe, wherein the search query is a query string comprising 5 words.

H: A computer-readable medium having thereon computer-executable instructions that responsive to execution configure a computer to perform a method as any one of paragraphs A-G describes.

I: A device or system comprising: a processor; and a computer-readable medium coupled to the processor, the computer-readable medium including instructions to configure one or more devices to perform a method as any of paragraphs A-G describes.

J: A device or system comprising: means for processing; and means for storing coupled to the means for processing, the means for storing, storing instructions to configure one or more devices to perform a method as any of paragraphs A-G describes.

K: A computing device, comprising: a processor; a memory comprising a data structure defining a plurality of tenants, individual tenants of the plurality of tenants are associated with criteria, the memory further comprising computer-executable instructions stored thereupon which, when executed by a computing device, cause the computing device to: receive a request from a tenant; determine a tenant type associated with the tenant based, at least in part, on the criteria; obtain data associating the tenant type with one or more responses; select at least one response of the one or more responses based, at least in part, on the tenant type; and generate an output comprising the at least one response.

L: A computing device as paragraph K describes, wherein the computer executable instructions further cause the computing device to: obtain data defining a historical effectiveness of the one or more responses; and determine a hierarchical rank of the one or more responses based at least in part on the data defining the historical effectiveness, wherein the selection of the at least one response of the one or more responses is based, at least in part, on the hierarchical rank.

M: A computing device as paragraphs K-L describe, wherein the computer-executable instructions further cause the computing device to: communicate the at least one response to the tenant; receive feedback associated with the at least one response; determine at least one success metric based on the feedback; and update a resource storing the data defining the historical effectiveness of the one or more responses, wherein the update includes the at least one success metric.

N: A computing device as paragraphs K-M describe, wherein the computer-executable instructions further cause the computing device to: prior to the selection of the at least one response to the request, obtain data defining a root cause analysis (RCA) of one or more requests; predict a root cause of the request based at least in part on the data defining the RCA; determine a search query; query one or more search engines; and receive a list of responses to the request.

O: A computing device as paragraph N describes, wherein the prediction of a root cause of the request comprises: applying one or more words of the request to a weighted dictionary; assigning a weight to the one or more words of the request; and mapping the one or more words based at least in part on the assigned weight.

P: A computing device as paragraphs K-O describe, wherein the criteria includes one or more of: a number of licenses associated with the tenant; a number of actual users associated with the tenant; and an age of the tenant.

Q: A computer storage medium having computer-executable instructions stored thereupon which, when executed by a computing device, cause the computing device to: receive a service request from a tenant; obtain data defining criteria associated with the tenant; obtain data associating the criteria with one or more solutions; select at least one solution based, at least in part, on the criteria and the data associating the criteria with the one or more solutions; and generate an output comprising the at least one response.

R: A computer storage medium as paragraph Q describes, wherein the computer storage medium has further computer-executable instructions, which cause the computing device to: obtain data defining a historical effectiveness of the at least one response; and determine a rank of the at least one response based at least in part on the data defining the historical effectiveness.

S: A computer storage medium as paragraphs Q-R describe, wherein the computer storage medium has further computer-executable instructions, which cause the computing device to: communicate the at least one response to the tenant; receive feedback associated with the at least one response; determine at least one success metric based on the feedback; and update a resource storing the data defining the historical effectiveness of the one or more responses, wherein the update includes the at least one success metric.

T: A computer storage medium as paragraphs Q-S describe, wherein the computer storage medium has further computer-executable instructions, which cause the computing device to: prior to the selection of the at least one solution, obtain data defining a root cause analysis (RCA) of one or more service requests; predict a root cause of the service request based at least in part on the data defining the RCA; determine a search query; query one or more search engines; and receive one or more solutions to the service request.

U: A computer storage medium as paragraph T describes, wherein the prediction of a root cause of the service request comprises: applying one or more words of the service request to a weighted dictionary; assigning a weight to the one or more words of the service request; and mapping the one or more words based at least in part on the assigned weight.

V: A computer storage medium as paragraph T describes, wherein the data defining the RCA comprises a distribution of root causes based on: the criteria associated with the tenant; and the service request.

W: A device or system comprising: a processor; and a computer storage medium as any of paragraphs Q-V describes coupled to the processor.

X: A system comprising: a processor; a memory; one or more applications stored in the memory and executed, at least in part, by the processor; and a solution module, stored in the memory, wherein the solution module is configured to discover one or more solutions to a request from a tenant based at least in part on a tenant type, and comprises a tenant data store; a root cause analysis module; and an efficacy database.

Y: A system as paragraph X describes, wherein the root cause analysis module is configured to: obtain data defining a root cause analysis (RCA) of the request; predict a root cause of the request based at least in part on the data defining the RCA; determine a search query; query one or more search engines; and receive a list of solutions to the request.

Z: A system as paragraph Y describes, wherein the root cause analysis module is further configured to: apply one or more words of the request to a weighted dictionary; assign a weight to the one or more words of the request; and map the one or more words based at least in part on the assigned weight.

AA: A system as paragraph Y-Z describes, wherein the search query is a string comprising 5 words.

AB: A system as paragraph X describes, wherein the tenant data store comprises characteristics associated with a tenant, the characteristics including one or more of: a number of licenses associated with the tenant; a number of actual users associated with the tenant; and an age of the tenant.

AC: A system as paragraphs X-AB describe, wherein the efficacy database is configured to: obtain data defining a historical effectiveness of the one or more solutions; determine a hierarchical rank of the one or more solutions based at least in part on the data defining the historical effectiveness; and select at least one solution of the one or more solutions based, at least in part on the hierarchical rank.

AD: A system as paragraph AC describes, wherein the solution module is further configured to: communicate the selected solution to the tenant.

AE: A system as paragraphs AC-AD describe, wherein the efficacy database is further configured to: receive feedback associated with the solution; determine at least one success metric based on the feedback; and update a resource storing the data defining the historical effectiveness of the one or more solutions, wherein the update includes the at least one success metric.

AF: A system as paragraph AE describes, wherein the solution module is further configured to: receive a second request from a second tenant, the second tenant being of the same type as the tenant; and determine a response to the second request based at least in part on the updated resource storing the data defining the historical effectiveness.

AG: A computer-readable medium having thereon computer-executable instructions that, responsive to execution, configure a computer to perform a system as any one of paragraphs X-AF describes.

AH: A device or method comprising: a processor; and a computer-readable medium coupled to the processor, the computer-readable medium including instructions to configure one or more devices to perform a method as any of paragraphs X-AF describes.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

Conditional language such as, among others, “can,” “could,” “might” or “may,” unless specifically stated otherwise, are otherwise understood within the context as used in general to present that certain examples include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. can be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate examples are included within the scope of the examples described herein in which elements or functions can be deleted, or executed out of order from that shown or discussed, including substantially synchronously or in reverse order, depending on the functionality involved as would be understood by those skilled in the art.

It should be emphasized that many variations and modifications can be made to the above-described examples, the elements of which are to be understood as being among other acceptable examples. All such modifications and variations are intended to be included herein within the scope of this disclosure and protected by the following claims.

What is claimed is:

1. A computer-implemented method, comprising:
receiving a request from a tenant;
obtaining data defining characteristics associated with the tenant;
determining a tenant type based on the characteristics;
determining a response to the request based, at least in part, on the tenant type; and
generating an output comprising the response.

2. The method of claim 1, further comprising:
obtaining data defining a historical effectiveness of one or more responses;
determining a hierarchical rank of the one or more responses based at least in part on the data defining the historical effectiveness; and
selecting at least one response of the one or more responses based, at least in part, on the hierarchical rank.

3. The method of claim 2, further comprising:
communicating the selected response to the tenant;
receiving feedback associated with the response;
determining at least one success metric based on the feedback; and
updating a resource storing the data defining the historical effectiveness of the one or more responses, wherein the update includes the at least one success metric.

4. The method of claim 3, further comprising:
receiving a second request from a second tenant, the second tenant being of the same type as the tenant; and
determining a response to the second request based at least in part on the updated resource storing the data defining the historical effectiveness.

5. The method of claim 1, further comprising:
prior to determining a response to the request, obtaining data defining a root cause analysis (RCA) of one or more requests;
predicting a root cause of the request based at least in part on the data defining the RCA;
determining a search query;
querying one or more search engines; and
receiving a list of responses to the request.

6. The method of claim 5, wherein the predicting a root cause of the request further comprises:
applying one or more words of the request to a weighted dictionary;
assigning a weight to the one or more words of the request; and
mapping the one or more words based at least in part on the assigned weight.

7. The method of claim 5, wherein the search query is a query string comprising 5 words.

8. The method of claim 1, wherein the characteristics include one or more of:
a number of licenses associated with the tenant;
a number of actual users associated with the tenant; and
an age of the tenant.

9. A computing device, comprising:
a processor;
a memory comprising a data structure defining a plurality of tenants, individual tenants of the plurality of tenants are associated with criteria, the memory further comprising computer-executable instructions stored thereupon which, when executed by a computing device, cause the computing device to:
receive a request from a tenant;
determine a tenant type associated with the tenant based, at least in part, on the criteria;
obtain data associating the tenant type with one or more responses;
select at least one response of the one or more responses based, at least in part, on the tenant type; and
generate an output comprising the at least one response.

10. The computing device of claim 9, wherein the computer-executable instructions further cause the computing device to:
obtain data defining a historical effectiveness of the one or more responses; and
determine a hierarchical rank of the one or more responses based at least in part on the data defining the historical effectiveness,
wherein the selection of the at least one response of the one or more responses is based, at least in part, on the hierarchical rank.

11. The computing device of claim 9, wherein the computer-executable instructions further cause the computing device to:
communicate the at least one response to the tenant;
receive feedback associated with the at least one response;
determine at least one success metric based on the feedback; and
update a resource storing the data defining the historical effectiveness of the one or more responses, wherein the update includes the at least one success metric.

12. The computing device of claim 9, wherein the computer-executable instructions further cause the computing device to:
prior to the selection of the at least one response to the request, obtain data defining a root cause analysis (RCA) of one or more requests;
predict a root cause of the request based at least in part on the data defining the RCA;
determine a search query;
query one or more search engines; and
receive a list of responses to the request.

13. The computing device of claim 12, wherein the prediction of a root cause of the request comprises:
applying one or more words of the request to a weighted dictionary;
assigning a weight to the one or more words of the request; and
mapping the one or more words based at least in part on the assigned weight.

14. The computing device of claim 9, wherein the criteria includes one or more of:
a number of licenses associated with the tenant;
a number of actual users associated with the tenant; and
an age of the tenant.

15. A computer storage medium having computer-executable instructions stored thereupon which, when executed by a computing device, cause the computing device to:
receive a service request from a tenant;
obtain data defining criteria associated with the tenant;
obtain data associating the criteria with one or more solutions;
select at least one solution based, at least in part, on the criteria and the data associating the criteria with the one or more solutions; and
generate an output comprising the at least one response.

16. The computer storage medium of claim 15, wherein the computer storage medium has further computer-executable instructions, which cause the computing device to:
obtain data defining a historical effectiveness of the at least one response; and
determine a rank of the at least one response based at least in part on the data defining the historical effectiveness.

17. The computer storage medium of claim 15, wherein the computer storage medium has further computer-executable instructions, which cause the computing device to:
communicate the at least one response to the tenant;
receive feedback associated with the at least one response;
determine at least one success metric based on the feedback; and
update a resource storing the data defining the historical effectiveness of the one or more responses, wherein the update includes the at least one success metric.

18. The computer storage medium of claim 15, wherein the computer storage medium has further computer-executable instructions, which cause the computing device to:
prior to the selection of the at least one solution, obtain data defining a root cause analysis (RCA) of one or more service requests;
predict a root cause of the service request based at least in part on the data defining the RCA;
determine a search query;
query one or more search engines; and
receive one or more solutions to the service request.

19. The computer storage medium of claim 18, wherein the prediction of a root cause of the service request comprises:
applying one or more words of the service request to a weighted dictionary;
assigning a weight to the one or more words of the service request; and
mapping the one or more words based at least in part on the assigned weight.

20. The computer storage medium of claim 18, wherein the data defining the RCA comprises a distribution of root causes based on:
the criteria associated with the tenant; and
the service request.
